(19) United States
(12) Patent Application Publication
(10) Pub. No.: US 2025/0171190 A1
(43) Pub. Date: May 29, 2025

(54) METHOD FOR OPERATING A LABELLING SYSTEM

(71) Applicant: Espera-Werke GmbH, Duisburg (DE)

(72) Inventors: Thorsten ZERFASS, Mülheim an der Ruhr (DE); Alexander SCHULZ, Mülheim an der Ruhr (DE)

(21) Appl. No.: 18/833,445

(22) PCT Filed: Jan. 19, 2023
(86) PCT No.: PCT/EP2023/051232

§ 371 Date: Jul. 26, 2024

(30) Foreign Application Priority Data
Jan. 27, 2022 (DE) 10 2022 101 940.3

(51) Int. Cl. B65C 9/42; B65C 9/18; B65C 9/46

(52) U.S. Cl. CPC B65C 9/42; B65C 9/18; B65C 9/46

(57) ABSTRACT

The invention relates to a method for operating a labelling system with at least one labelling device (1) for labelling, in particular price labelling, individual packets (2), wherein the labelling device (1) comprises, as functional units, at least one weighing arrangement (3) for determining a weight of the packet (2), a dispensing arrangement (4) for dispensing a label (5) from a material strip (6) and a printer arrangement (7) for printing the label (5), wherein the labelling device (1) comprises a sensor arrangement (13) by means of which operating values assigned to the functional units are determined and transmitted to an evaluation arrangement (14) of the labelling system. According to the invention, a future maintenance date for at least one of the functional units is predicted by means of the evaluation arrangement (14) using a predefined predictive model based on the operating values.

### CROSS-REFERENCE TO RELATED APPLICATIONS

This application is a U.S. national stage of PCT/EP2023/051232, filed Jan. 19, 2023, and claims priority to DE 10 2022 101 940.3, filed Jan. 27, 2022.

### BACKGROUND OF INVENTION

### Field of Invention

The invention relates to a method for the operation of a labeling system, to an evaluation arrangement for a labeling system, to a labeling system and to a computer program product.

### Brief Description of Related Art

The labeling system of the type in question here for the labeling of individual packages comprises at least one labeling device, which is configured in particular as a price tagging device. The labeling device is equipped inter alia with a weighing arrangement and a dispensing arrangement for labels as functional units, which are intended for the labeling of the individual packages. A printer arrangement is provided for printing the labels, wherein the printing may also take place as a function of a weight value determined by means of the weighing arrangement.

In order to monitor the operation, the functional units have sensing means, which determine operating values associated with carrying out the labeling. The operating values may be used for driving in the functional units and also for fault detection. In one known method (EP 3 616 932 A1), the determination of a wear indicator is provided for a printer arrangement, maintenance of the printer arrangement being instigated for example when a threshold value for the wear indicator is reached.

Such a labeling system is supervised for example in a production management system, which specifies the further course of operation in a processing plan. In order to optimize the processing plan, an important role is attached to estimating the availability of resources. A failure of functional units of the labeling device may, in the absence of planning, lead to significant production losses.

### BRIEF SUMMARY OF THE INVENTION

The invention is based on the problem of specifying a method for the operation of a labeling system, which enables improved productivity by optimal utilization of available resources.

The aforementioned problem is solved by the features of the inventions disclosed and claimed herein.

What is essential is the basic idea that the operating values determined during operation not only may be used for fault detection and for recording an acute maintenance requirement, but also allow early estimation of a future maintenance requirement. It has been discovered that, in particular from the time profile of the operating values, it is possible to predict with sufficient accuracy when a maintenance requirement occurs, for example because of wear of individual functional units. The maintenance requirement may therefore be incorporated early on into the operation planning, so that the risk of production downtimes is reduced.

In detail, it is proposed that a future maintenance instant for at least one of the functional units is predicted by means of the evaluation arrangement with the aid of a predetermined prediction model on the basis of the operating values.

In a preferred embodiment, a time dependency of the operating values that has been determined is used for an extrapolation, so that trends in the operating values can be used for a reliable prediction.

Threshold values for operating values or quantities derived therefrom may be established, so that the prediction model can be parameterized in a straightforward way.

Likewise, a trained machine learning model may be employed to compile the prediction, so that in particular a complex time dependency of a multiplicity of operating values can be included in the prediction.

The model parameters of the prediction model, in a preferred embodiment, are adapted to the respective labeling device in a configuration routine and therefore individualized, so that the reliability of the prediction can be improved overall.

Different variants of operating values, which may be used for the prediction, are also disclosed. The operating values are preferentially already parameters recorded in the scope of the labeling routine, so that additional sensing means are not necessarily required for the prediction of the maintenance instant.

In a preferred embodiment, the evaluation arrangement is configured to give the predicted maintenance instant with a confidence interval, which describes the prediction quality of the predicted maintenance instant and thus allows an expression of the reliability of the prediction.

Particularly preferred is the further embodiment, which provides interaction with a production management system in order to compile a processing plan. The processing plan may on the one hand take the predicted maintenance instant into account, in order to use the prediction for process optimization. On the other hand, the processing plan is preferentially taken into account in the prediction, since for example the wear that occurs may be dependent on the respective planned processing.

In a further embodiment, planned, for example regular, maintenance instants are additionally provided, which are preferably compared with the predicted maintenance instants in order to reduce a stoppage of the labeling device as comprehensively as possible.

Likewise preferred is an embodiment, in which, in order to avoid production downtimes, the availability of maintenance means for the predicted maintenance instant can be checked and they can be therefore requested promptly when required.

Preferentially, an output of the predicted maintenance instant is carried out.

According to a further teaching, to which independent importance is attributed, an evaluation arrangement for a labeling system is claimed.

What is essential in this case is that the evaluation arrangement predicts a future maintenance instant for at least one of the functional units with the aid of a predetermined prediction model on the basis of the operating values. All comments relating to the method may be referred to.

The evaluation arrangement may, in a preferred embodiment, be configured to also carry out the driving of the functional units in the scope of the labeling of the packages, in addition to the generation of the prediction.

According to a further teaching, to which independent importance is likewise attributed, a labeling system for carrying out the method as proposed is claimed. All comments relating to the method may likewise be referred to.

According to a further teaching, to which independent importance is likewise attributed, a computer program product is claimed, having commands which, when executed on a computer of an evaluation arrangement of a labeling system, cause the evaluation arrangement to carry out the method as proposed. All comments relating to the method are likewise referred to.

### BRIEF DESCRIPTION OF THE DRAWINGS

The invention will be explained in more detail below with the aid of drawings, which represent merely exemplary embodiments. In the drawing:

FIG. 1 shows a schematic representation of the labeling system as proposed, having an evaluation arrangement as proposed for carrying out the method as proposed; and

FIG. 2 shows an exemplary time profile of operating values.

### DETAILED DESCRIPTION OF THE INVENTION

The invention relates to a method for the operation of a labeling system. The labeling system is equipped with at least one labeling device 1 for the labeling of individual packages 2, which is configured in particular as a price tagging device.

The labeling device 1 comprises as functional units at least one weighing arrangement 3 for determining a weight value of the package 2, a dispensing arrangement 4 for dispensing a label 5 from a material strip 6, and a printer arrangement 7 for printing the label 5. Besides these aforementioned functional units, further functional units may also be provided. Likewise, the labeling system may also comprise a plurality of labeling devices 1, in particular as described here.

In one embodiment of the labeling system (not represented), the labeling device 1 is intended for partially manual labeling of the packages. For example, the package 2 is placed manually by the operator onto the weighing arrangement 3, a label 5 printed by the printer arrangement 7 being dispensed by means of the dispensing arrangement 4. The application of the label 5 onto the package 2 is, for example, likewise carried out manually.

The weighing arrangement 3 is used to determine weight values of the respective package 2. The weighing arrangement 3 comprises a weighing cell, which determines analog and/or digital weight values representative of the weight of the package 2. The determination of the weight values takes place in particular on the basis of a deformation measurement of a supporting plate for the packages 2, for instance by means of strain gauges, and/or on the basis of an electromagnetic force compensation for the weight force of the respective package 2.

The dispensing arrangement 4 is provided for dispensing the label 5, which may be configured to be releasable from a material strip 6. A label 5 releasable from a material strip 6 means in particular a label 5 that is applied releasably with its adhesive face on a carrier strip, which forms the material strip 6 and may for example consist of paper and/or plastic. It is likewise possible for the label 5 to be produced by separating a subsection from a printable or printed material strip 6, for example by cutting and/or tearing the material strip 6. In particular, labels 5 configured as adhesive labels are used, which already have an adhesive face by means of which they are fastened releasably on the material strip 6. Likewise, it is also conceivable to use adhesive-free labels 5, which are only subsequently provided with an adhesive face or are applied onto an adhesive face on the respective package 2.

The printer arrangement 7 is provided for printing the label 5, wherein printing of the label 5 may in principle take place on the material strip 6 and/or after release of the label 5 from the material strip 6 as well as before, after or during the application of the label 5 onto the respective package 2. Here, and preferably, a printer arrangement 7 configured for thermal printing, in particular thermal direct printing or thermal transfer printing, is provided.

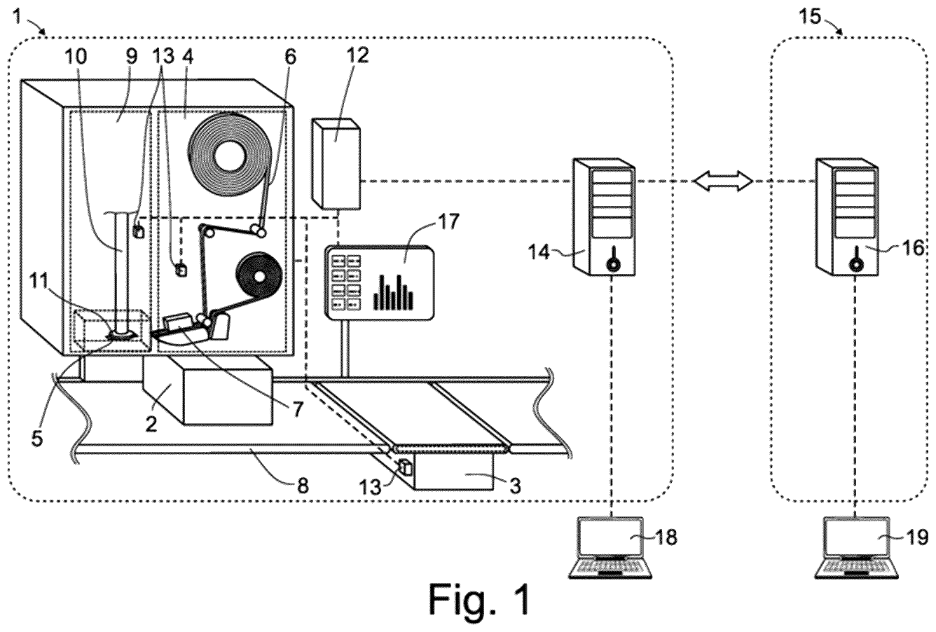

Besides the functional units already mentioned, the embodiment of the labeling device 1 shown in FIG. 1 also comprises further functional units, which implement substantially automated and continuous labeling of the packages 2.

As a further functional unit, a forward feed arrangement 8 for transporting respective packages 2 is provided. The forward feed arrangement 8 is preferentially a belt conveyor or a roller conveyor, also optionally at least one robot arm, for moving the respective packages 2. The forward feed arrangement 8, here the belt conveyor, here and preferably comprises at least one conveyor belt by means of which the respective packages 2 are transported along a transport direction.

Preferably, the weighing arrangement 3 is configured as a dynamic weighing arrangement, which determines the weight values of moved packages 2 and therefore enables the continuous operation of the labeling device 1. In FIG. 1, the weighing arrangement 3 is correspondingly provided on the forward feed arrangement 8. The printer arrangement 7 and/or an additional printer arrangement (not represented here) may likewise be provided on the forward feed arrangement 8, and may for example print the moved package 2, in particular the label 5 applied onto the package 2.

The labeling device 1 also comprises, here in a common housing with the dispensing arrangement 4, as a further functional unit an application arrangement 9 for applying the dispensed label 5 onto the respective package 2. Preferably, the dispensed label 5 is taken up by a stamp, which here and preferably is configured as a reciprocating stamp 10, and is applied onto the respective package 2. In particular, the stamp comprises a blow head 11 for taking up the label 5 by suction and blowing it off. The reciprocating stamp 10 in this case executes a movement along the transport direction during the application, in order to allow labeling of the package 2 moved by means of the forward feed arrangement 8. With the application arrangement 9, the label 5 can be applied in contact by pressing the label 5 onto the package 2. In addition or alternatively, it is conceivable for the label 5 to be applied contactlessly, for example with the blow head 11 of the stamp blowing the label 5 off onto the package 2 by generating a compressed air impulse directed toward the package 2.

The labeling device 1 further comprises an operation controller 12. In a labeling routine, the functional units are driven by means of the operation controller 12 in order to label the individual packages 2. In the labeling routine, respective packages 2 are transported by means of the forward feed arrangement 8, a label 5 dispensed from a material strip 6 by the dispensing arrangement 4 being applied onto the respective package 2 by means of the application arrangement 9, and the label 5 being printed by means of the printer arrangement 7. The operation controller 12 for this purpose preferably comprises control electronics for implementing the control tasks that arise in the scope of the labeling routine. The operation controller 12 may, as also represented in a simplified manner in FIG. 1, be a central operation controller 12 of the labeling system and/or of the labeling device 1, which drives all or at least some of the functional units. It is likewise possible for the operation controller 12 to comprise a plurality of decentral control units that communicate with one another, preferably with each functional unit respectively being assigned a control unit.

The labeling device 1 comprises a sensor arrangement 13, by means of which operating values assigned to the functional units are determined. Here, the term sensor arrangement 13 includes sensor units assigned to the functional units. The sensor data determined by the respective sensor units are in particular processed and transmitted as operating values to the operation controller 12, and are used in particular to monitor and drive the functional units in the labeling routine.

Here, the sensor units comprise at least one sensor, and preferably a plurality of sensors, which determine operating values for example on the basis of optical, acoustic, mechanical and/or electronic measurement quantities. An operating value may be understood here as an operating state, for example the temperature or speed or acceleration of a component. It is likewise conceivable for the sensor arrangement 13 to determine, for example, the operating duration of a component as operating values.

The labeling system also comprises an evaluation arrangement 14, to which the operating values are transmitted. The evaluation arrangement 14 may for example, as represented in FIG. 1, be a server for the labeling system, which is superordinate to the operation controller 12 and carries out an evaluation of the operating values, which is yet to be described below. Here, the evaluation arrangement 14 is connected via a local communication network to the operation controller 12 and/or to the sensor arrangement 13. It is, however, also possible for the operation controller 12 to constitute a component of the evaluation arrangement 14.

Further, here and preferably, the connection of the evaluation arrangement 14 to a cloud 15 that comprises at least one cloud server 16 is provided. It is conceivable for at least some of the tasks that arise at the evaluation arrangement 14 to be observed by means of the cloud server 16. In the embodiment represented, however, an evaluation of the operating values is carried out for example locally on the labeling device 1 by means of the evaluation arrangement 14.

What is now essential is that a future maintenance instant for at least one of the functional units is predicted by means of the evaluation arrangement 14 with the aid of a predetermined prediction model on the basis of the operating values.

Here, a prediction model refers to a model that enables the prediction of an output variable in the future as a function of at least one function variable. Such a prediction model uses here in particular the time profile of at least one function variable in the past, and predicts the output variable from this time profile. In particular, the future maintenance instant is used as an output variable. Here, the operating values or quantities derived therefrom are used as function variables.

The predicted maintenance instant may be established for individual components of the labeling device 1 or for a module consisting of a plurality of components. The maintenance instant may either be used here to prevent wear-related failure of one of the components or of a part of a component, but also be provided for safeguarding against a reduction of the performance or quality of the labeling routine induced by wear or other effects.

Further, here and preferably, it is provided that the predetermined prediction model is based on a time dependency of the operating values, preferably on an extrapolation of the time dependency of the operating values.

In particular, various regression methods may be used here, for example linear regression, nonparametric or semiparametric regression, for instance multivariate adaptive regression splines, or robust regression methods such as least-squares estimation or maximum likelihood estimation.

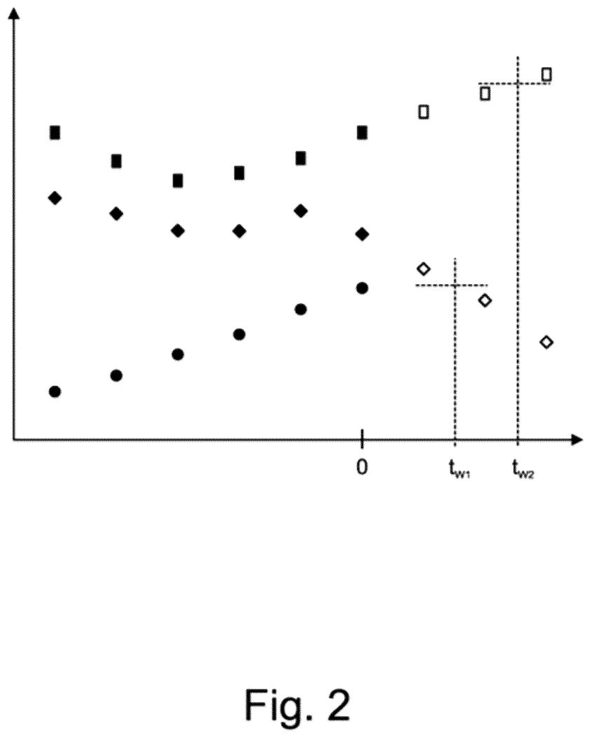

FIG. 2 shows exemplary profiles of a first operating value (represented as rhombi) and of a second operating value (represented as rectangles) as a function of time t. Up to the instant t=0, the operating values have been recorded here and their time dependency has been stored by means of the evaluation arrangement 14 (filled symbols in FIG. 2). Here, for example, a further time profile of the first and second operating values is predicted from the time dependencies, this being represented by the open symbols. Besides discrete predicted values for the operating values, the prediction may also be given as a continuous function.

The prediction for one of the operating values need not necessarily be compiled exclusively here from the same operating value. FIG. 2 represents a third operating value with circles, the first and/or second operating value being for example related to the third operating value. The prediction for the first and/or second operating value may be determined here as a function of the time profile of the third operating value.

Further, here and preferably, it is provided that the prediction model contains at least one threshold value for an operating value or for a quantity derived from the operating values as a model parameter, and that the predicted maintenance instant is determined with the aid of the threshold value being reached, which is predicted from the operating values.

The threshold value may constitute both an upper and a lower limit for an operating value or a quantity derived from the operating values, as well as a threshold value corridor. Likewise, there may be a plurality of threshold values with a different meaning for an operating value or a derived quantity. For instance, it is conceivable that a maintenance instant lying relatively far in the future is predicted when a first threshold value for the electrical power consumption of a drive component is exceeded, and a maintenance instant lying less far in the future is predicted when a second, higher threshold value is exceeded.

FIG. 2 indicates by way of example threshold values for the first and second operating values, which are employed to predict the maintenance instants t_{W1} and t_{W2}.

A plurality of operating values may be combined to form a further, superordinate quantity, or a further quantity may be derived from one or more operating values. The combination of a plurality of operating values may, for example, take place here by means of an individual weighting of the various operating values. For example, the increase of the electrical power consumption of an actuator will be assigned a higher weighting than the measurement value, likewise used to generate the combined value, of a vibration sensor. The combined quantity may also be generated from derived values of an operating value or a plurality of operating values.

Machine learning methods, for example artificial neural networks or least-squares support vector machines, may be used in particular for regression compilation and for prediction. In one preferred embodiment, it is provided here that the predetermined prediction model contains a machine learning model trained in order to generate the predicted maintenance instant from operating values.

Here, a machine learning model is an algorithm that is capable of generating a probable output dataset from a predetermined amount of input data and associated output data for an unknown input dataset. The predetermined input dataset, also referred to as a training dataset, is used here for the so-called training of the machine learning model. This training may take place as supervised or unsupervised learning. Here, and preferably, the machine learning model is trained with a supervised learning concept. In the latter, the association of an input dataset with the associated output dataset is known, so that the learning outcome is the recognition of a functional or regressive relation between the input and output data.

The machine learning model may for example be an artificial neural network, but also decision trees, support vector machines, Bayesian networks or other machine learning methods may be used as a basis for the prediction model.

The trained machine learning model generates, for example, a prediction about the further time profile of individual operating values, the future maintenance instant being determined therefrom, in particular with a comparison by means of at least one threshold value. The future maintenance instant may likewise be an output datum of the trained machine learning model.

The training of the machine learning model may already take place before initialization of the labeling system, and the model resulting from the training may be stored in the evaluation arrangement 14. It is, however, also conceivable for the machine learning model to be trained or further developed during the operation of the labeling system in a learning routine. For example, for this purpose a comparison of a prediction for the operating values, which is generated by means of the machine learning model, with the further time profile of the recorded operating values takes place. Consequently, the data collected during ongoing operation relating to the operating values can be employed for the further training of the machine learning model, so that the machine learning model is adapted in particular to the individual requirements of the respective labeling device 1.

Further, here and preferably, it is provided that the prediction model contains model parameters that are determined by means of the evaluation arrangement 14 in a configuration routine with the aid of the operating values.

In one advantageous embodiment, the prediction model may contain model parameters that establish a functional relation between the operating values and the output variables, for example in the form of coefficients or the like. Model parameters may also for example mean weights, threshold values or specifications of the activation function, which are used in artificial neural networks.

Since such model parameters depend on the physical conditions of the individual labeling system, the values of the model parameters may differ for two different labeling devices 1 of the same type, according to the environment or specific configuration. It is therefore provided that the values of the model parameters are determined by means of the evaluation arrangement 14 in a configuration routine with the aid of the operating values. This may, for example, be done by operating the labeling system in various predetermined operating modes and/or for various labeling processes and here registering and evaluating the operating values.

Preferably, it is thus the case that the configuration routine is performed with the initialization so that the labeling device 1 is set up with an optimized starting configuration for the prediction model. Further, the configuration routine may in principle take place during operation, particularly in a time-controlled manner and for example at regular time intervals. In particular, the time-controlled performance of the configuration routine makes it possible to adapt the prediction model even over a prolonged operating period of the labeling system of several years to changing conditions, for example due to modified material specifications, environmental conditions or minor geometrical changes of the structural parts of the labeling system.

In principle, the operating values may be all measurable and estimable quantities that arise in the context of the operation of the labeling system. Particularly advantageous operating values are representative of at least one of the following values: the operating duration of at least one functional unit; a speed assigned to the functional unit, in particular the forward feed speed, application speed and/or printing speed; temperature, pressure, humidity and/or air speed; the number of packages 2 processed, of start processes, of labels 5 and/or material strips 6 used; the package weight 2 of the processed packages 2; the number of recorded collisions between a functional arrangement, in particular the dispensing arrangement 4, and packages 2 and/or step losses; and/or drive values of electrical actuators of the functional units.

The operating duration means a duration of use summed over the operation of the functional unit, in particular a length of time during which the functional unit is turned on and/or a length of time during which the functional unit is active and, for example, is processing a package 2.

The forward feed speed may, for example, be specified by means of the speed of the belt of the forward feed arrangement 8 or else by means of an angular velocity of a roller, or the like. The application speed is, in particular, the speed of a component of the application arrangement 9 during the application of the label 5, and preferably is the angular velocity of the reciprocating stamp 10. The printing speed means, in particular, the speed of the label 5 on the printer arrangement 7. Besides the speed, the distance traveled by the respective components may also be used as operating values.

The temperature, pressure, humidity and air speed are in particular parameters of the air conditions at the location of the labeling device 1, and specifically at individual functional units which may have an influence on the labeling routine. The temperature of a component, for example of an actuator, of the print head of the printer arrangement 7, or the like, may also be employed as operating values. The pressure at pneumatic or hydraulic components, here for example at the blow head 11 and/or at the associated compressed-air system, may likewise be used as an operating value.

The number of packages 2 processed, of start processes, of labels 5 and/or material strips 6 used may likewise have a significant influence on the wear of the components and are preferably recorded as operating values. A start process means a start-up of the labeling device 1, with which in particular continuous labeling is begun after stopping. A large number of material strips 6 used corresponds to material strips 6 being replaced frequently in the dispensing arrangement 4, so that a maintenance requirement may occur.

The package weight of the processed packages 2 is determined by means of the weighing arrangement 3. The cumulative package weight 2 of the packages 2 per se may be employed here as operating values. Likewise, threshold values such as maximum values may be specified for the package weight 2, with an excess weight of the packages 2, weight classes of the packages 2, or the like, being determined as operating values.

As error situations, collisions between the dispensing arrangement 4 and packages 2 and step losses during the labeling may occur. Corresponding events may be recorded, and their number may in particular be included in operating values.

Drive values of electrical actuators of the functional units mean for example a drive current, a drive voltage, rotational speeds of electric motors, or the like. An operating value may likewise be representative of an overcurrent of the actuator, for example of the length of time or the number of times that a maximum drive current is exceeded. Examples of electrical actuators are the drive motors of the forward feed arrangement 8 and drive motors for moving the material strip 6 in the dispensing arrangement 4.

Operating values for electronic control components may likewise be recorded, in particular of the operation controller 12, of the evaluation arrangement 14 or else of the sensor arrangement 13. For example, the voltage, current, temperature and/or cooling power at electronic components are recorded.

Operating values that relate to the setting up and/or calibration of the weighing arrangement 3 are further conceivable.

Since prediction models are always subject to an uncertainty, a time interval with an earliest maintenance instant and a latest maintenance instant may be determined for the predicted maintenance instant, the earliest maintenance instant and the latest maintenance instant describing the bounds of a confidence interval with a predetermined confidence. The time interval may correspond to the p-confidence interval of the true value of the maintenance instant. The interval bounds are then described as the earliest and latest maintenance instants, so that the period between the earliest and latest maintenance instants contains the true maintenance instant with a probability of p. The parameter p is here at least 0.5, preferably however at least 0.8 and more preferably 0.95.

In order to be able to insert downtimes of the labeling system, which are caused by maintenance work, optimally into the operating sequence, and to adapt the operating sequence to maintenance work in an optimized manner, here and preferably it is provided that the predicted maintenance instant is transmitted by means of the evaluation arrangement 14 to a production management system of the labeling system, which compiles a processing plan for the operation of the labeling system. The production management system may compile the processing plan for the operation of the labeling system as a function of the predicted maintenance instant. For example, the production management system may be configured, for example, to set various processing blocks chronologically in relation to the predicted maintenance instant in such a way that the maintenance coincides chronologically with a preparatory process incurred by the conversion from one processing block to the other.

Likewise, it may be provided that the processing plan is transmitted to the evaluation arrangement 14 by means of the production management system and the prediction model is defined as a function of the processing plan. Correspondingly, the processing blocks planned in the future may be taken into account in the prediction of the maintenance period, for instance so as to predict an earlier maintenance instant in the event of a large number of intensive processing steps.

It is furthermore conceivable that deterministically predetermined maintenance instants are jointly taken into account with the prediction, for example when they are prescribed by statutory guidelines. Here, and preferably, it is provided that predetermined maintenance instants are stored which are output by means of the evaluation arrangement 14 in addition to the predicted maintenance instants, preferably that the processing plan is compiled by means of the production management system in such a way that a predicted maintenance instant coincides with one of the predetermined maintenance instants.

In this way, it is possible that for instance statutorily predetermined maintenance instants, or running times of wear components that are restricted because of warranty rights, are included in the planning of the maintenance instants, and a further reduction of the downtimes and therefore an increase in the efficiency are thereby made possible.

Further, here and preferably, it is provided that at least one maintenance means, in particular a replacement part or tool, is assigned by means of the evaluation arrangement 14 to the predicted maintenance instant with the aid of a maintenance specification.

The maintenance means may be here an exchange part, in particular a wear part, such as a bearing, a filter or a coupling, but also a replacement part for a defective component, or a component for which the risk of early failure is high based on the data of the prediction model. The maintenance means is not, however, restricted to exchange parts. For instance, the maintenance means may also be a tool required for maintenance, for example a special measuring instrument or a joining tool. It is likewise conceivable for the maintenance part to be a component of the labeling system, for which the decision whether replacement of the component is necessary is not taken until during the maintenance process. Besides the maintenance means, maintenance personnel may also be assigned to the predicted maintenance instant.

The assignment of a maintenance means is particularly advantageous when the evaluation arrangement 14 requests the availability of the maintenance means in a warehouse management system at the predicted maintenance instant. In this way, it is possible to ensure that all maintenance means required for the maintenance are available at the maintenance instant and no delays occur during the maintenance. The evaluation arrangement 14 may also be configured to log the requirement in the warehouse management system, so that an ordering process is initiated in the event of unavailability for example of a replacement part.

Further, here and preferably, it is provided that an output of the predicted maintenance instant and at least some of the current operating values and/or quantities dependent on the operating values by a display device 17, 18, 19 is instigated by means of the evaluation arrangement 14.

The display device 17, 18, 19 may be here a graphical output unit, for example a display 17 on the labeling device 1 or a display 18, 19 of a terminal, for example a mobile device, which is in communication with the evaluation arrangement 14 or with the cloud server 16. Likewise, the display device 17, 18, 19 may be a mechanical output unit in the form of a pointer needle, or the like. Besides the predicted maintenance instant, the display device 17, 18, 19 preferably also outputs operating values or quantities derived therefrom. Temperatures, power consumptions or pressures, but also dimensionless characteristics, for example variations relative to base values of an operating value, may for example be output here. This enables the operator to obtain a more detailed estimation of the current operating situation.

Furthermore, according to a further teaching to which independent importance is attributed, an evaluation arrangement 14 is also claimed for a labeling system with at least one labeling device 1 for the labeling, in particular for the price tagging, of individual packages 2, wherein the labeling device 1 comprises as functional units at least one weighing arrangement 3 for determining a weight value of the package 2, a dispensing arrangement 4 for dispensing a label 5 from a material strip 6, and a printer arrangement 7 for printing the label 5, wherein the evaluation arrangement 14 obtains operating values assigned to the functional units from a sensor arrangement 13 of the labeling device 1.

What is essential in this case is that the evaluation arrangement 14 predicts a future maintenance instant for at least one of the functional units with the aid of a predetermined prediction model on the basis of the operating values. Reference is made to the comments regarding the method.

Preferably, the evaluation arrangement 14 is also configured to drive the functional units for the labeling of the individual packages 2 in a labeling routine. In this regard, the evaluation arrangement 14 may contain the operation controller 12 already described.

Furthermore, according to a further teaching to which independent importance is attributed, a labeling system for carrying out the proposed method is claimed.

Furthermore, according to a further teaching to which independent importance is attributed, a computer program product is claimed, having commands which, when executed on a computer of an evaluation arrangement 14 of a labeling system, cause the evaluation arrangement to carry out the proposed method.

The computer program product is preferably saved on an electronic memory. Particularly preferentially, the evaluation arrangement 14 comprises a memory in which the commands of the computer program product are stored, and at least one processor for executing the program instructions, the memory and the commands being configured to drive, together with the processor, the labeling system in order to carry out the method as proposed.

The memory preferably comprises a nonvolatile memory for the program instructions, for example a flash memory, an EEPROM memory, a magnetic memory and/or an optical memory. The memory may further be equipped with a working memory, preferably a random access working memory (RAM), or the like. The processor preferably comprises a microprocessor, a digital signal processor and/or an application-specific integrated circuit.

1-15. (canceled)

16. A method for the operation of a labeling system with at least one labeling device for the labeling of a package, the labeling device including, as functional units, at least one weighing arrangement for determining a weight value of the package, a dispensing arrangement for dispensing a label from a material strip, and a printer arrangement for printing the label, the labeling device further including a sensor arrangement by means of which operating values assigned to the functional units are determined and transmitted to an evaluation arrangement of the labeling system, the method comprising predicting a future maintenance instant for at least one of the functional units by means of the evaluation arrangement with the aid of a predetermined prediction model on the basis of the operating values.

17. The method as claimed in claim 16, wherein the predetermined prediction model is based on a time dependency of the operating values.

18. The method as claimed in claim 17, wherein the predetermined prediction model is based on an extrapolation of the time dependency of the operating values.

19. The method as claimed in claim 16, wherein the prediction model contains at least one threshold value for an operating value or for a quantity derived from the operating values as a model parameter, and wherein the predicted maintenance instant is determined with the aid of the threshold value being reached, which is predicted from the operating values.

20. The method as claimed in claim 16, wherein the predetermined prediction model contains a machine learning model trained in order to generate the predicted maintenance instant from the operating values.

21. The method as claimed in claim 16, wherein the prediction model contains model parameters that are determined by means of the evaluation arrangement in a configuration routine with the aid of the operating values.

22. The method as claimed in claim 21, wherein the configuration routine is performed with the initialization of the labeling device and/or in a time-controlled manner.

23. The method as claimed in claim 16, wherein the operating values are representative of at least one of: the operating duration of at least one functional unit; a speed assigned to the functional unit; temperature, pressure and/or humidity; the number of packages processed, of start processes, of labels and/or material strips used; the package weight of the packages processed; the number of recorded collisions between the dispensing arrangement and the packages processed and/or step losses; and/or drive values of electrical actuators of the functional units.

24. The method claimed as in claim 23, wherein the speed is a forward feed speed, an application speed and/or a printing speed.

25. The method as claimed in claim 16, wherein a time interval with an earliest maintenance instant and a latest maintenance instant is determined for the predicted maintenance instant, the earliest maintenance instant and the latest maintenance instant describing the bounds of a confidence interval with a predetermined confidence.

26. The method as claimed in claim 16, wherein the predicted maintenance instant is transmitted by means of the evaluation arrangement to a production management system of the labeling system, which compiles a processing plan for the operation of the labeling system, and/or wherein the processing plan is transmitted to the evaluation arrangement by means of the production management system and wherein the prediction model is defined as a function of the processing plan.

27. The method according to claim 26, wherein the production management system of the labeling system comprises the processing plan for the operation of the labeling system as a function of the predicted maintenance instant.

28. The method as claimed in claim 16, wherein predetermined maintenance instants are stored which are output by means of the evaluation arrangement in addition to the predicted maintenance instants.

29. The method as claimed in claim 28, wherein the processing plan is compiled by means of the production management system in such a way that a predicted maintenance instant coincides with one of the predetermined maintenance instants.

30. The method as claimed in claim 16, wherein at least one maintenance means is assigned by means of the evaluation arrangement to the predicted maintenance instant with the aid of a maintenance specification.

31. The method as claimed in claim 30, wherein the at least one maintenance means is a replacement part or a tool.

32. The method as claimed in claim 30, wherein the availability of the maintenance means in a warehouse management system at the predicted maintenance instant is requested by means of the evaluation arrangement.

33. The method as claimed in claim 16, wherein an output of the predicted maintenance instant and at least some of the current operating values and/or quantities dependent on the operating values by a display device is instigated by means of the evaluation arrangement.

34. An evaluation arrangement for a labeling system with at least one labeling device for the labeling of a package, the labeling device including, as functional units, at least one weighing arrangement for determining a weight value of the package, a dispensing arrangement for dispensing a label from a material strip, and a printer arrangement for printing the label, the evaluation arrangement being configured to obtain operating values assigned to the functional units from a sensor arrangement of the labeling device, the method comprising the evaluation arrangement predicting a future maintenance instant for at least one of the functional units with the aid of a predetermined prediction model on the basis of the operating values.

35. The evaluation arrangement as claimed in claim 34, wherein the evaluation arrangement is configured to drive the functional units for the labeling of the individual packages in a labeling routine.

36. A labeling system configured for carrying out a method as claimed in 16.

37. A computer program product having commands which, when executed on a computer of an evaluation arrangement of a labeling system, cause the evaluation arrangement to carry out the method as claimed in claim 16.
